(19) United States
(12) Patent Application Publication
(10) Pub. No.: US 2021/0130938 A1
(43) Pub. Date: May 6, 2021

(54) COLD ROLLED ENAMELING SHEET STEEL WITH ENHANCED FORMABILITY AND PROCESS FOR MANUFACTURING SAME

(71) Applicant: AK Steel Properties, Inc., West Chester, OH (US)

(72) Inventors: Amrinder Singh Gill, West Chester, OH (US); Jeffrey Douglas Alder, Eaton, OH (US)

(21) Appl. No.: 17/087,950

(22) Filed: Nov. 3, 2020

Related U.S. Application Data
(60) Provisional application No. 62/930,239, filed on Nov. 4, 2019.

(51) Int. Cl. C22C 38/06; C22C 38/04; C22C 38/00; C22C 38/02; C22C 38/16; C21D 8/02

(52) U.S. Cl. CPC C22C 38/06; C22C 38/04; C22C 38/001; C22C 38/002; C03C 8/00; C22C 38/16; C21D 8/0236; C21D 8/0205; C22C 38/02

(57) ABSTRACT

A cold-rolled enameling sheet steel has equivalent or better properties than the prior art Type 1 enameling sheet steel and approaches the formability of a Type 3 enameling sheet steel.

### PRIORITY

This application claims priority to U.S. Provisional Application Ser. No. 62/930,239, filed Nov. 4, 2019, entitled “Cold Rolled Enameling Sheet Steel with Enhanced Formability,” the disclosure of which is incorporated herein by reference.

### BACKGROUND

This invention pertains to the production of improved cold-rolled sheet steel meant for enameling. A method to make an enameling sheet steel with improved formability, sag resistance, and strength after strain and firing compared to prior art Type 1 enameling sheet steel is also provided.

Enameling sheet steels are used to make parts utilized in manufacturing products such as appliances, architectural panels, and sanitary wares. Parts are formed from these steels, a porcelain enamel coating(s) applied and then eventually the parts are fired, sometimes multiple times, to form a continuous glass surface.

There are generally three types of enameling sheet steels. They are described in ASTM specification A424 as Type 1, Type 2, and Type 3 steels. These steels exhibit several characteristics. It is desirable that enameling sheet steels exhibit good formability as characterized by elongation, measured by tensile test and high plastic strain anisotropy or r-value (rₘ), also called r-average or r-bar. rₘ is a measure of resistance to thinning during drawing, with higher rₘ indicating a better drawability and hence better ability to form more complicated shapes. The normal anisotropy parameter rₘ is a good indicator for drawability of material.

It is desirable that enameling sheet steels also exhibit good fish scale resistance, which means that these steels have structures that facilitate the storage of hydrogen generated during firing of enamel. Without these internal traps, hydrogen generated during the enameling process travels to the steel-enamel interface and can result in chipping of enamel. This defect is called fish scale.

It is further desirable that enameling sheet steels also exhibit good resistance to sag during the firing process. Sag resistance refers to change in the shape of the formed part due to creep of the enameling sheet steel during the firing process.

It is desirable that enameling sheet steel also exhibit good strength after forming and firing of the enamel. This ensures that the final component retains good mechanical properties.

It is desirable that enameling sheet steels also be resistant to carbon boil during enamel firing. Carbon boiling occurs when the carbides present in steel react with oxygen in the frit (a powdered mix of various ingredients of enamel) to form CO (carbon monoxide) or CO₂ (carbon dioxide). This can lead to formation of defects in the enamel.

In addition, it is desirable that enameling sheet steels exhibit good aging properties. Strain aging happens in steel when carbon or nitrogen atoms diffuse to dislocation defects in steel and impede the dislocation motion. This results in discontinuous yielding behavior in steel and can lead to defects like stretcher strains.

As described in the ASTM specification A424, Type 1 enameling sheet steels have low carbon content achieved by decarburization, good sag resistance, and good formability. These steels are suitable for a single coat or multiple coat enameling process. Type 2 enameling sheet steels have higher carbon content, making them suitable for only certain enameling processes. Type 3 enameling sheet steels are interstitial free steels, which leads to excellent formability. They also have good sag resistance.

### SUMMARY

The current application describes cold-rolled enameling sheet steels that have equivalent or better properties than the prior art Type 1 enameling sheet steels and approach the mechanical properties of Type 3 enameling sheet steels. In certain embodiments, the mechanical properties of the present enameling sheet steels are at least equivalent to Type 1 enameling sheet steel. In certain embodiments, the formability of the present steels is superior to Type 1 enameling sheet steel and the sag and strength after strain and firing performance is better than Type 1 enameling sheet steel. Certain embodiments of the present steels can be used in applications typically reserved for Type 3 enameling sheet steels without the drawbacks associated with the use of titanium, which is included in the prior art Type 3 enameling sheet steels.

### DESCRIPTION OF DRAWINGS

FIG. 1 shows the microstructure obtained from a finished coil from Heat 1 of Example 1 in a longitudinal orientation.

FIG. 2 shows the microstructure obtained from a finished coil from Heat 2 of Example 1 in a longitudinal orientation.

FIG. 3 shows a higher magnification image of the microstructure and boron nitride inclusions from a finished coil from Heat 2 of Example 1 in a longitudinal orientation.

FIG. 4. shows a higher magnification scanning electron microscope (SEM) image of boron nitride inclusions from a finished coil from Heat 2 of Example 1.

FIG. 5 shows the comparative results of a sag test obtained from an embodiment of the present invention and a prior art Type 1 enameling sheet steel.

FIG. 6 depicts comparative strength after a strain and firing test for the enameling sheet steels of Example 1 and a prior art Type 1 enameling sheet steel.

### DETAILED DESCRIPTION

In typical prior art Type 1 enameling sheet steels, formability is often limited with typical rₘ<1.3. Type 3 enameling sheet steels typically have rₘ values of approximately 1.7 or higher. In prior art Type 3 enameling sheet steel, enhanced formability is achieved by the use of carbon scavenging elements like titanium or niobium. However, the addition of Ti or Nb leads to an increase in production cost. Additionally, carbides or nitrides thus formed can lead to defects like black spots during enameling. The enameling sheet steels of the present application use aluminum nitride precipitation to attain suitable microstructure and textures that lead to high formability, characterized by higher rₘ. The same mechanism also helps in the improvement of strength after strain and firing of the enameling sheet steels.

In prior art enameling sheet steels, the fish scale resistance is achieved by creating tears, microvoids, or discontinuities in the steel substrate. These microvoids are created by fracturing of carbides (in a Type 1 enameling sheet steel) or titanium carbo-nitrides (in the case of Type 3 enameling sheet steel) during cold rolling. Prior art Type 1 enameling sheet steel is subject to a decarburizing treatment, typically an open coil anneal process. The enameling sheet steels of the present application achieve a fish scale resistance by the use of boron nitrides that are fractured during cold rolling. To avoid the risk of carbon boiling, a low carbon content is obtained by suitable melt practices, such as vacuum degassing, rather than a decarburizing heat treatment. The present enameling sheet steels keep the manufacturing costs low by avoiding the use of Ti and Nb and by avoiding the need for an open coil anneal treatment.

The present enameling sheet steels provide an improvement in sag resistance by keeping the carbon level low during the melt practices.

Good aging resistance in the present enameling sheet steels is achieved by keeping solute carbon and nitrogen to low levels. The enameling sheet steels of the present application achieve good aging resistance by attaining low carbon during steel-making operations. The nitrogen in the steel is scavenged by either boron or aluminum, leaving little or no free nitrogen.

Typical compositions for prior art Type 1 enameling sheet steel (for example, Univit® enameling sheet steel available from AK Steel Corporation, West Chester, Ohio), and Type 3 enameling sheet steel (for example, I-F enameling sheet steel also available from AK Steel) are set forth in Table 1 below:

TABLE 1

| | C | Mn | P(max) | S(max) | Si(max) | Cu | Al | Ti |
|---|---|---|---|---|---|---|---|---|
| Type 1 | 0.003 | 0.21 | 0.01 | 0.01 | 0.01 | 0.02 | 0.05 | — |
| Type 3 | 0.005 | 0.20 | 0.01 | 0.01 | 0.01 | 0.02 | 0.05 | 0.13 |

Typical mechanical properties for prior art Type 1 enameling sheet steel (for example, Univit® enameling sheet steel available from AK Steel Corporation, West Chester, Ohio), and Type 3 enameling sheet steel (for example, I-F enameling sheet steel also available from AK Steel) are set forth in Table 2 below:

TABLE 2

| | YS, | UTS, | Total El. | | |
|---|---|---|---|---|---|
| | ksi | ksi | In 2″, % | n-value | rₘ |
| Type 1 | 26 | 44 | 42 | 0.22 | <1.3 |
| Type 3 | 20 | 43 | 48 | 0.24 | 1.7 |

Exemplary enameling sheet steel embodiments of the present invention comprise the following elements, as shown in Table 3, along with iron and inevitable impurities.

TABLE 3

| | C | Mn | P | S | Si | B | Al | N |
|---|---|---|---|---|---|---|---|---|
| Min (wt %) | 0.0020 | 0.25 | | | | 0.006 | 0.025 | 0.012 |
| Max (wt. %) | 0.0030 | 0.35 | 0.015 | 0.015 | 0.030 | 0.008 | 0.080 | 0.018 |
| Preferred | 0.0020- | 0.25- | <0.01 | <0.010 | <0.01 | 0.007- | 0.025- | 0.012- |
| range | 0.0025 | 0.3 | | | | 0.008 | 0.050 | 0.0140 |

Carbon (C) is limited to a maximum of 0.0030 wt. %. C is kept low to provide good resistance to aging, improve formability, provide good sag resistance and provide good enameling characteristics. However, lowering C adds to the cost of steel making. Hence, the lower limit of carbon is kept at 0.0020 wt. %. In some embodiments, the C content is maintained between 0.0020-0.0025 wt. %.

Manganese (Mn) helps scavenge S by forming MnS precipitates. S is usually present in steel as an undesirable impurity and can form harmful iron sulfides. A small amount of Mn, preferably about 0.25 wt. % is included to capture S. Mn is limited to a maximum of 0.35 wt. % as Mn is a solid solution strengthener and hence can deteriorate the workability of steel at higher levels. In some embodiments, the Mn content is maintained between 0.025-0.03 wt. %.

Phosphorus (P) is kept at a maximum of 0.015 wt. % because, at higher levels, it can have an adverse effect on the pickling of hot bands. Phosphorus is also a solid solution strengthener of steels and a high amount of P will affect the workability of steel. In some embodiments, the P content is maintained below 0.01 wt. %.

Sulphur (S) is generally considered an undesirable element that can cause hot shortness in steel during hot rolling. S can form phases with low melting temperatures (e.g., iron sulfide) along the grain boundaries. At high temperatures, this can lead to cracks along the grain boundaries, causing hot shortness. Hence, its maximum level is limited to 0.015 wt. %. In some embodiments, the S content is maintained below 0.010 wt. %.

Silicon (Si) is not an intentional addition in this enameling sheet steel. It may be present because of the composition of scrap material used in steel making, or as a residual from ore or deoxidizing agents. Si is kept to a 0.030 wt. % maximum because in higher amounts it can adversely affect the workability of steel. In some embodiments, the Si content is maintained below 0.010 wt. %.

Boron (B) is an important element in the enameling sheet steels of the present application. B forms boron nitrides (BN) during solidification. These BN plastically deform during hot rolling and eventually are pulled apart during the cold rolling and create tears in the substrate. These fractured inclusions and tears act as discontinuities and as sites for hydrogen storage during the firing process. A minimum level of boron is set at 0.0060 wt. % to encourage formation of BN inclusions. The amount of B is such that after combining with N to form BN inclusions, there is at least 10 ppm free N to combine with Al. In some embodiments, the amount of B is such that after the formation of BN inclusions, there are 20 ppm or higher free N available to combine with Al to form AlN. In some embodiments, the maximum level of B is set at 0.0080 wt. %. In other embodiments, the level of B is maintained between 0.007-0.008 wt. %.

Aluminum (Al) is added to deoxidize the steel. A minimum amount of 0.025 wt. % is deemed effective for this purpose. In embodiments of the enameling sheet steels of the present application, aluminum is also used to capture any nitrogen that remains after tying up with boron. This helps with avoiding aging from solute nitrogen. Also, aluminum nitride (AlN) precipitates thus formed help in the development of textures that are favorable for deep drawing. To that end, the maximum level of Al is set at 0.080 wt. %. In some embodiments, the level of Al is maintained between 0.025-0.050 wt. %.

Nitrogen (N) has two functions in the enameling sheet steels of the present application. One is to form BN inclusions to provide fish scale resistance. The second is to form AlN precipitates to achieve better formability. It is preferred that after combining with B and Al, there is no free N left. In some embodiments, the level of N is maintained between 0.012-0.018 wt. %. In other embodiments, the level of N is maintained between 0.012-0.014 wt. %.

The current steel is produced by using melt practices designed to keep C level low and then is cast into slabs. These slabs are then hot rolled, pickled, cold rolled, box annealed and temper rolled. During hot rolling, the finishing and coiling temperatures are chosen with a desire to keep N in solution at this point. Later on, after cold rolling the material is box annealed. The slow heat up in a box annealing process allows for precipitation of AlN precipitates and is performed at a temperature no greater than Ac3 Temperature. After box annealing, temper rolling is performed to obtain desired surface finish and mechanical properties.

### Example 1

An embodiment of the present invention is now described. Two heats were prepared in a production facility using the components identified in Table 4, by weight percent, plus iron and impurities.

TABLE 4

| | | | | | | | | | N not |
|---|---|---|---|---|---|---|---|---|---|
| | | | | | | | | | combined |
| | C | Mn | P | S | Si | B | Al | N | with B |
| Heat 1 | 0.0020 | 0.30 | 0.0060 | 0.0110 | 0.0060 | 0.0064 | 0.0380 | 0.074 | −0.0009 |
| Heat 2 | 0.0023 | 0.32 | 0.0057 | 0.0102 | 0.0052 | 0.0070 | 0.302 | 0.0135 | 0.0044 |

Heat 1 does not fall within the current invention but is being compared to Heat 2 to elucidate the advantages offered by an exemplary composition of the invention. For reference, N that is not combined with B is also included in Table 4. A negative number indicates that no free N was available after combining with B.

The steel was vacuum degassed to get to the C levels desired. Nitrogen additions were then made. After the steel was killed with Al, Mn additions were made followed by B additions. These heats were then cast. Analysis performed on slab samples from each heat confirmed the formation of BN inclusions.

The slabs were then hot-rolled by reheating to a temperature of approximately 2260° F. (1238° C.). The finishing temperature for hot rolling was approximately 1660° F. (904° C.) and a coiling aim temperature of approximately 1020° F. (549° C.). The hot rolling parameters were set up in this manner to effectively keep the remaining N in solution.

After cooling, the coils were then pickled and cold reduced by 69-75%. After cold reduction, the coils were tight coil annealed at a cold spot aim temperature of approximately 1275° F. (691° C.) in a 100% hydrogen atmosphere. During this step, it is believed that the free N combines with Al and starts to form AlN during the recovery part of annealing. AlN thus formed generates favorable textures that help in enhancing drawability of steel. After cooling, the coils were temper rolled.

Table 5 shows the properties obtained from coils processed in the above manner for both heats.

TABLE 5

| | 0.2% Yield | | Total | | |
|---|---|---|---|---|---|
| | Strength | UTS | Elongation | | |
| | (ksi) | (ksi) | (%) | n | rₘ |
| Heat 1 | 20.9 | 41.6 | 44.4 | 0.246 | 1.20 |
| Heat 2 | 23.9 | 42.1 | 42.9 | 0.212 | 1.83 |

The tensile properties described are in the longitudinal direction and represent averages from all the coils processed. rₘ is normal anisotropy and is described as rₘ=(r₀+r₉₀+2r₄₅)/4. The coils obtained from Heat 2 exhibited a much superior rₘ.

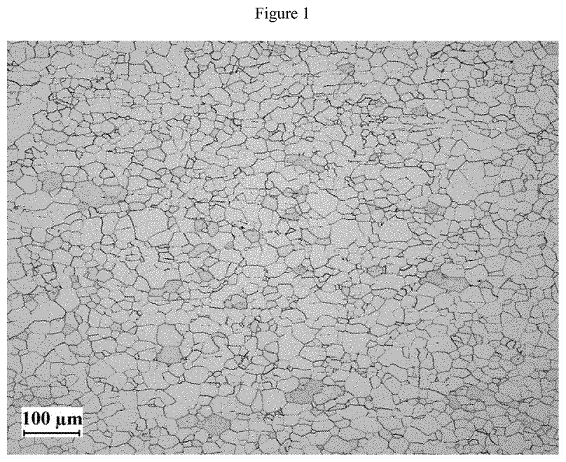

FIG. 1 shows the microstructure obtained from a finished coil from Heat 1. The grain structure obtained is equiaxed with grain size rated at ASTM grain size number 8 or higher.

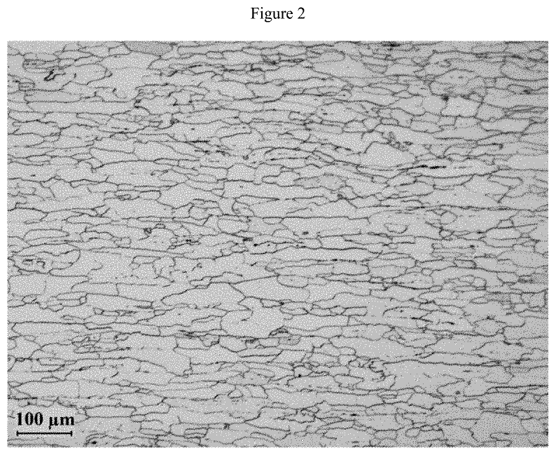

FIG. 2 shows the microstructure obtained from a finished coil from Heat 2 in a longitudinal orientation. The grain structure obtained is pancaked with grain size rated at ASTM grain size number 6 or higher. The pancake structure of grains is an indication that AlN precipitation took place and has developed desirable textures.

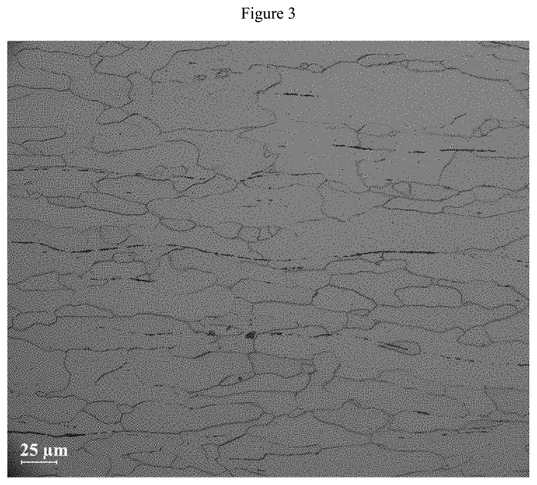

FIG. 3 shows a higher magnification image of the microstructure from a finished coil from Heat 2, in a longitudinal orientation. The long, dark stringer like BN inclusions are clearly visible. The discontinuous nature of the elongated inclusions is also apparent, indicating that these inclusions got pulled apart during cold rolling operation.

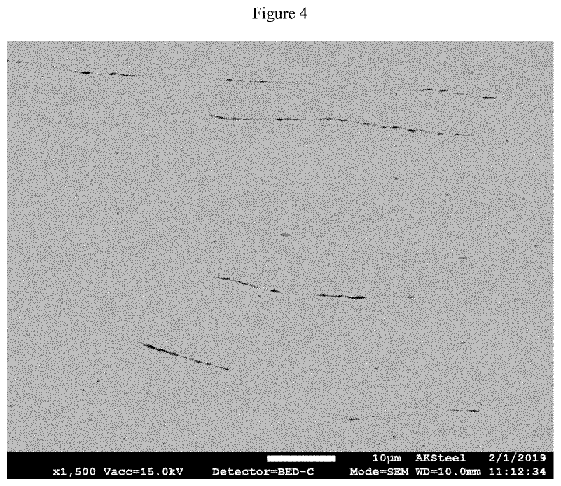

FIG. 4 shows a higher magnification image of BN inclusions from a finished coil from Heat 2. The elongated and fractured BN inclusions are apparent.

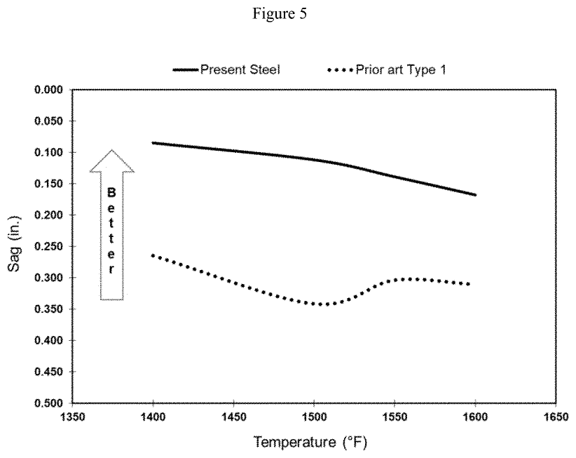

FIG. 5 shows the results of a sag test, performed at a temperature of 1400-1600° F., comparing the prior art Type 1 enameling sheet steel to the present steel. It is readily apparent that the present steel shows a lower sag across the temperature range of the test.

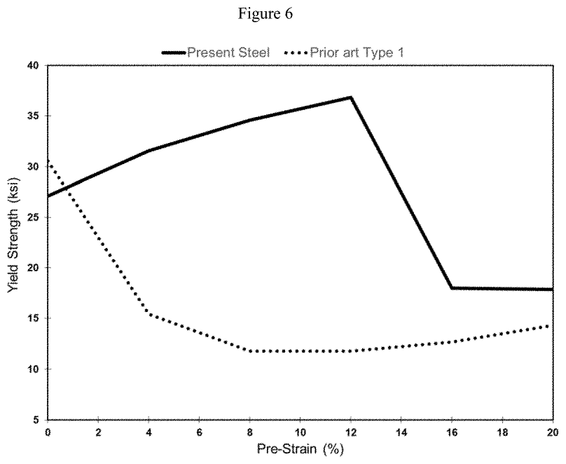

FIG. 6 shows the results of a strength after strain and firing test performed at 1500° F., comparing the prior art Type 1 enameling sheet steel to an embodiment of the present steel. This test is conducted by pre-straining the specimen to different strain levels and exposing them to a thermal cycle broadly representative of an enamel firing operation. It is readily apparent that the present steel shows higher yield strength after application of strain and firing operation. Similar trends were noted at other testing temperatures from 1450-1550° F.

### Example 2

Embodiments of the present enameling sheet steels (sheet compositions 7-29) and comparative examples (sheet compositions 1-6, denoted with an * in the tables below) were made by processes similar to those described in Example 1 above using the chemical compositions of Table 6 below plus iron and impurities.

TABLE 6

| | | | | | | | | | | N not |
|---|---|---|---|---|---|---|---|---|---|---|
| Sheet | | | | | | | | | | combined |
| Composition | | | | | | | | | | with B |
| # | C | Mn | P | S | Si | Cu | Al | N | B | (PPM) |
| 1* | 0.0023 | 0.3 | 0.005 | 0.0115 | 0.004 | 0.059 | 0.042 | 0.0091 | 0.0073 | −4 |
| 2* | 0.0019 | 0.3 | 0.005 | 0.0114 | 0.004 | 0.058 | 0.041 | 0.0084 | 0.0074 | −12 |
| 3* | 0.0026 | 0.3 | 0.004 | 0.0106 | 0.004 | 0.06 | 0.04 | 0.0081 | 0.007 | −10 |
| 4* | 0.0026 | 0.3 | 0.004 | 0.0108 | 0.004 | 0.061 | 0.04 | 0.0082 | 0.0076 | −17 |
| 5* | 0.0024 | 0.31 | 0.008 | 0.0158 | 0.003 | 0.064 | 0.054 | 0.0072 | 0.0081 | −33 |
| 6* | 0.0027 | 0.31 | 0.009 | 0.0163 | 0.003 | 0.061 | 0.055 | 0.0075 | 0.0084 | −34 |
| 7 | 0.0022 | 0.29 | 0.006 | 0.0108 | 0.003 | 0.05 | 0.033 | 0.013 | 0.0081 | 25 |
| 8 | 0.0022 | 0.3 | 0.005 | 0.0106 | 0.003 | 0.05 | 0.031 | 0.013 | 0.0082 | 24 |
| 9 | 0.0019 | 0.28 | 0.006 | 0.0112 | <0.003 | 0.047 | 0.042 | 0.013 | 0.0073 | 35 |
| 10 | 0.0025 | 0.28 | 0.007 | 0.0113 | <0.003 | 0.048 | 0.043 | 0.013 | 0.0074 | 34 |
| 11 | 0.0029 | 0.27 | 0.006 | 0.0108 | 0.004 | 0.047 | 0.043 | 0.012 | 0.0079 | 18 |
| 12 | 0.0025 | 0.27 | 0.006 | 0.0108 | 0.004 | 0.047 | 0.043 | 0.012 | 0.0073 | 25 |
| 13 | 0.0027 | 0.27 | 0.006 | 0.0108 | 0.003 | 0.048 | 0.043 | 0.013 | 0.0071 | 38 |
| 14 | 0.0026 | 0.27 | 0.006 | 0.0109 | 0.003 | 0.047 | 0.041 | 0.013 | 0.0071 | 38 |
| 15 | 0.003 | 0.29 | 0.01 | 0.0119 | 0.005 | 0.066 | 0.041 | 0.013 | 0.0083 | 22 |
| 16 | 0.0021 | 0.29 | 0.011 | 0.012 | 0.005 | 0.063 | 0.039 | 0.013 | 0.0084 | 21 |
| 17 | 0.0021 | 0.28 | 0.007 | 0.0114 | 0.004 | 0.059 | 0.043 | 0.014 | 0.0083 | 32 |
| 18 | 0.0025 | 0.28 | 0.007 | 0.0114 | 0.004 | 0.06 | 0.047 | 0.014 | 0.0081 | 35 |
| 19 | 0.0025 | 0.28 | 0.007 | 0.0115 | 0.004 | 0.058 | 0.038 | 0.014 | 0.0069 | 51 |
| 20 | 0.0024 | 0.28 | 0.006 | 0.0116 | 0.004 | 0.056 | 0.044 | 0.014 | 0.0073 | 45 |
| 21 | 0.0023 | 0.28 | 0.006 | 0.0118 | 0.004 | 0.056 | 0.047 | 0.014 | 0.0072 | 47 |
| 22 | 0.0026 | 0.28 | 0.006 | 0.0118 | 0.003 | 0.056 | 0.047 | 0.014 | 0.007 | 49 |
| 23 | 0.0019 | 0.28 | 0.006 | 0.0117 | 0.003 | 0.058 | 0.046 | 0.013 | 0.0072 | 37 |
| 24 | 0.0019 | 0.28 | 0.006 | 0.0116 | 0.004 | 0.058 | 0.048 | 0.014 | 0.0076 | 41 |
| 25 | 0.0025 | 0.25 | 0.007 | 0.0117 | 0.004 | 0.056 | 0.044 | 0.014 | 0.0071 | 48 |
| 26 | 0.0023 | 0.25 | 0.007 | 0.0116 | 0.005 | 0.058 | 0.045 | 0.013 | 0.0073 | 35 |
| 27 | 0.0024 | 0.25 | 0.007 | 0.012 | 0.004 | 0.059 | 0.039 | 0.013 | 0.0073 | 35 |
| 28 | 0.0025 | 0.25 | 0.007 | 0.0118 | 0.004 | 0.06 | 0.043 | 0.014 | 0.0073 | 45 |
| 29 | 0.0024 | 0.25 | 0.007 | 0.0118 | 0.004 | 0.06 | 0.042 | 0.013 | 0.0076 | 31 |

Note:
a negative value indicates no nitrogen was left after combining with boron.

The present enameling sheet steel's resistance to sagging during the firing process was measured at a sheet gauge of 0.034″ and the results tabulated in Table 7 below. Sag is calculated by calculating the difference between initial deflection of a sample and then deflection was measured after the sample was exposed to a temperature for a certain time.

TABLE 7

| Temperature | |
|---|---|
| (° F.) | Sag (in.) |
| 1400 | 0.085 |
| 1500 | 0.112 |
| 1550 | 0.139 |
| 1600 | 0.168 |

Table 8 provides the mechanical properties data for the enameling sheet steels of the present example.

TABLE 8

| | | | | | | | | Nitrogen | | Free N after |
|---|---|---|---|---|---|---|---|---|---|---|
| Sheet | Nominal | | | Total | | | | not | | combining |
| Composition | Gauge | YS | UTS | Elong. | | | | combined | Al | with B and Al |
| # | (in.) | (ksi) | (ksi) | (%) | rₘ | N | B | with B* | (wt. %) | (ppm) |
| 1* | 0.044 | 20.4 | 41.5 | 44.7 | 1.20 | 0.0091 | 0.0073 | −4 | 0.0420 | −221 |
| 2* | 0.044 | 21.1 | 41.5 | 44.2 | 1.20 | 0.0084 | 0.0074 | −12 | 0.0410 | −225 |
| 3* | 0.036 | 20.8 | 41.3 | 47.5 | 1.38 | 0.0081 | 0.0070 | −10 | 0.0400 | −217 |
| 4* | 0.036 | 23.6 | 42.6 | 46.6 | 1.26 | 0.0082 | 0.0076 | −17 | 0.0400 | −224 |
| 5* | 0.033 | 23.1 | 43.4 | 44.1 | 1.41 | 0.0072 | 0.0081 | −33 | 0.054 | −313 |
| 6* | 0.033 | 23.2 | 43.3 | 43.5 | 1.35 | 0.0075 | 0.0084 | −34 | 0.055 | −319 |
| 7 | 0.033 | 23.7 | 42.1 | 41.8 | 1.77 | 0.013 | 0.0081 | 25 | 0.0330 | −146 |
| 8 | 0.033 | 23.1 | 41.4 | 43.2 | 1.74 | 0.013 | 0.0082 | 24 | 0.0310 | −137 |
| 9 | 0.033 | 24.7 | 42.6 | 43.7 | 1.86 | 0.013 | 0.0073 | 35 | 0.0420 | −182 |
| 10 | 0.033 | 24.2 | 42.6 | 43.8 | 1.89 | 0.013 | 0.0074 | 34 | 0.0430 | −189 |
| 11 | 0.044 | 22.7 | 41.6 | 43.2 | 1.84 | 0.012 | 0.0079 | 18 | 0.043 | −205 |
| 12 | 0.044 | 22.1 | 41.2 | 44.9 | 1.87 | 0.012 | 0.0073 | 25 | 0.043 | −198 |
| 13 | 0.044 | 21.8 | 41.3 | 44 | 1.85 | 0.013 | 0.0071 | 38 | 0.043 | −185 |
| 14 | 0.044 | 23.1 | 41.6 | 44 | 1.87 | 0.013 | 0.0071 | 38 | 0.041 | −175 |
| 15 | 0.036 | 24 | 42.8 | 39.9 | 1.77 | 0.013 | 0.0083 | 22 | 0.041 | −190 |
| 16 | 0.036 | 23.7 | 42.7 | 41.2 | 1.78 | 0.013 | 0.0084 | 21 | 0.039 | −181 |
| 17 | 0.036 | 22.3 | 42.3 | 44.2 | 1.79 | 0.014 | 0.0083 | 32 | 0.043 | −191 |
| 18 | 0.036 | 25.7 | 42.9 | 36 | 1.83 | 0.014 | 0.0081 | 35 | 0.044 | −193 |
| 19 | 0.036 | 23 | 42.3 | 46.2 | 1.76 | 0.014 | 0.0069 | 51 | 0.039 | −152 |
| 20 | 0.036 | 22.1 | 42.2 | 44.9 | 1.77 | 0.014 | 0.0073 | 45 | 0.042 | −172 |
| 21 | 0.036 | 22.6 | 41.8 | 45.8 | 1.72 | 0.014 | 0.0072 | 47 | 0.048 | −202 |
| 22 | 0.036 | 22.6 | 42.2 | 43 | 1.82 | 0.014 | 0.007 | 49 | 0.048 | −200 |
| 23 | 0.036 | 22.3 | 41.8 | 45.5 | 1.71 | 0.013 | 0.0072 | 37 | 0.045 | −197 |
| 24 | 0.036 | 22.5 | 41.8 | 45 | 1.78 | 0.014 | 0.0076 | 41 | 0.048 | −207 |
| 25 | 0.033 | 23.8 | 42.4 | 44.1 | 1.9 | 0.014 | 0.0071 | 48 | 0.044 | −180 |
| 26 | 0.033 | 24.3 | 42.6 | 43.2 | 2.01 | 0.013 | 0.0073 | 35 | 0.043 | −188 |
| 27 | 0.033 | 25 | 42.8 | 42.9 | 1.91 | 0.013 | 0.0073 | 35 | 0.039 | −167 |
| 28 | 0.033 | 22.9 | 41.8 | 43.2 | 2.02 | 0.014 | 0.0073 | 45 | 0.043 | −178 |
| 29 | 0.033 | 24.7 | 42.7 | 42.2 | 1.94 | 0.013 | 0.0076 | 31 | 0.042 | −186 |

Note:
A negative number indicates no free N was present

Heat 1 (sheet compositions 1-6) had no free N after combining with B exhibited low rₘ, while Heat 2 had free N left after combining with B exhibited higher rₘ. Also, no free N was left in any of the Heats after combining with B and Al.

### Example 3

An enameling sheet steel comprises 0.002-0.003 wt. % C; 0.25-0.35 wt % Mn, no more than 0.015 wt. % P, no more than 0.015 wt. % S, no more than 0.03 wt. % Si, at least 0.006 wt. % B, 0.025-0.08 wt. % Al, 0.012-0.018 wt. % N, and the balance Fe and impurities, and wherein there is sufficient B such that after combining with the N to form BN inclusions, there is at least 10 ppm free N to combine with the Al.

### Example 4

An enameling sheet steel of one or more of Example 3, and any of the following examples, includes at least 20 ppm N after combining with the B.

### Example 5

An enameling sheet steel of one or more of Examples 3, 4, and any of the following examples, has no free N left after combining with the B and the Al.

### Example 6

An enameling sheet steel of one or more of Examples 3-5, and any of the following examples, comprises 0.0020-0.0025 wt. % C.

### Example 7

An enameling sheet steel of one or more of Examples 3-6, and any of the following examples, comprises 0.25-0.30 wt. % Mn.

### Example 8

An enameling sheet steel of one or more of Examples 3-7, and any of the following examples, comprises less than 0.01 wt. % P.

### Example 9

An enameling sheet steel of one or more of Examples 3-8, and any of the following examples, comprises less than 0.010 wt. % S.

### Example 10

An enameling sheet steel of one or more of Examples 3-9, and any of the following examples, comprises less than 0.01 wt. % Si.

### Example 11

An enameling sheet steel of one or more of Examples 3-10, and any of the following examples, comprises 0.006-0.008 wt. % B.

### Example 12

An enameling sheet steel of one or more of Examples 3-11, and any of the following examples, comprises 0.007-0.008 wt. % B.

### Example 13

An enameling sheet steel of one or more of Examples 3-12, and any of the following examples, comprises 0.025-0.050 wt. % Al.

### Example 14

An enameling sheet steel of one or more of Examples 3-13, and any of the following examples, comprises 0.012-0.014 wt % N.

### Example 15

An enameling sheet steel of one or more of Examples 3-14 has an rₘ of at least about 1.7.

What is claimed is:

1. An enameling sheet steel comprising 0.002-0.003 wt. % C; 0.25-0.35 wt % Mn, no more than 0.015 wt. % P, no more than 0.015 wt. % S, no more than 0.03 wt. % Si, at least 0.006 wt. % B, 0.025-0.08 wt. % Al, 0.012-0.018 wt. % N, and the balance Fe and impurities, and wherein there is sufficient B such that after combining with the N to form BN inclusions, there is at least 10 ppm free N to combine with the Al.

2. The enameling sheet steel of claim 1 wherein the steel includes at least 20 ppm N after combining with the B.

3. The enameling sheet steel of claim 1 or 2 where no free N is left after combining with the B and the Al.

4. The enameling sheet steel of claim 1 or 2 comprising 0.0020-0.0025 wt. % C.

5. The enameling sheet steel of claim 1 or 2 comprising 0.25-0.30 wt. % Mn.

6. The enameling sheet steel of claim 1 or 2 comprising less than 0.01 wt. % P.

7. The enameling sheet steel of claim 1 or 2 comprising less than 0.010 wt. % S.

8. The enameling sheet steel of claim 1 or 2 comprising less than 0.01 wt. % Si.

9. The enameling sheet steel of claim 1 or 2 comprising 0.006-0.008 wt. % B.

10. The enameling sheet steel of claim 9 comprising 0.007-0.008 wt. % B.

11. The enameling sheet steel of claim 1 or 2 comprising 0.025-0.050 wt. % Al.

12. The enameling sheet steel of claim 1 or 2 comprising 0.012-0.014 wt % N.

13. The enameling sheet steel of claim 1 or 2 wherein the enameling sheet steel has an rₘ of at least about 1.7.
